(19) United States
(12) Patent Application Publication
(10) Pub. No.: US 2010/0145769 A1
(43) Pub. Date: Jun. 10, 2010

(54) SYSTEM AND METHOD FOR PRODUCT INQUIRY AND INCENTIVE FOR VIRTUAL UNIVERSES

(75) Inventors: Rick A. Hamilton, II, Charlotesville, VA (US); Paul A. Moskowitz, Yorktown Heights, NY (US); Clifford A. Pickover, Yorktown Heights, NY (US); Robert Wisniewski, Ossining, NY (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INTERNATIONAL BUSINESS MACHINES CORPORATION, Armonk, NY (US)

(21) Appl. No.: 12/330,699

(22) Filed: Dec. 9, 2008

(51) Int. Cl. G06Q 30/00; G06F 17/40; G06F 17/30

(52) U.S. Cl. 705/10; 707/E17.044; 705/14.27; 705/14.66

(57) ABSTRACT

A system and method for inquiring about products and providing incentives to users participating in a virtual universe. The system comprises an information tracking system configured to track information about at least one of a product, a service, and one or more user purchasing the product or service based on obtained information associated with the product or service and the one or more users. The incentive system provides incentives for frequent purchases and incentives for time spent proximate to virtual universe product areas. The system also comprises a storage system configured to aggregate information obtained from the information tracking system to build a profile.

### FIELD OF THE INVENTION

The invention generally relates to a system and method for inquiring about products and, in particular, to inquiring about products and providing incentives to users participating in a virtual universe.

### BACKGROUND OF THE INVENTION

Virtual universes (VUs) are computer-based simulations of the real world where users interact with one another using online identities. These online identities, known as avatars, are used to graphically represent users within a VU. Although there are many different types of VUs, there are several features many VUs generally have in common. These features include, for example,
Shared Space: the VU allows many users to participate at once;
Graphical User Interface: the VU depicts space visually, ranging in style from 2D “cartoon” imagery to more immersive 3D environments;
Immediacy: interaction takes place in real time;
Interactivity: the VU allows users to alter, develop, build, or submit customized content;
Persistence: the VU's existence continues regardless of whether individual users are logged in; and
Socialization/Community: the VU allows and encourages the formation of social groups such as teams, guilds, clubs, cliques, housemates, neighborhoods, etc.

Many of a user's experiences within a VU involve moving the user's avatar through the shared space. This movement allows avatars to engage in social interactions and conduct business transactions. These business transactions can mirror real life business transactions and include everything from purchasing a soda to buying and selling virtual properties located within the VU.

As VUs become more complex, the opportunities for avatar events such as business meetings, lectures, and social gatherings increase. Thus, it is becoming more important not only for businesses to attract customers to their businesses, but also for businesses to keep customers coming back to their virtual business. The effectiveness of a business in retaining customers is referred to as “stickiness.” The more stickiness a business has, the more customers return to the business and the more brand recognition the business receives. Therefore, it is beneficial for businesses in both the real world and in VUs to increase the stickiness associated with their business. Additionally, it is beneficial for particular VUs to work with businesses to provide features and environments so as to encourage people to return to their VU.

### SUMMARY OF THE INVENTION

In a first aspect of the invention, the invention includes an Information Tracking System configured to track information about at least one of a product, a service, and one or more user purchasing the product or service based on obtained information associated with the product or service and the one or more users. The invention also comprises a storage system configured to aggregate information obtained from the Information Tracking System to build a profile within a VU.

In a second aspect of the invention it is the proximity to a special region within the VU associated with a given product that triggers particular incentives, which may include any one or more of: VU currency, points, inventory items, access to restricted areas or functions, avatar function enhancement, avatar representation enhancement, virtual property.

In another aspect of the invention, a method for tracking information in a VU tracks information on at least one of a product, a service, or a user. The method also aggregates the tracked information in a database and generates a profile on at least one of the product, the service, or the user based on the tracked information.

In another aspect of the invention, a system for deploying an application for tracking information, comprises a computer infrastructure being operable to: track product information, service information, and user information in a VU; aggregate the tracked information in a database; and provide the tracked information to one or more entities.

In yet another aspect of the invention, a computer program product comprising a computer usable medium having computer readable program code embodied in the medium to: track information about a product, a service, and/or a user in a VU; accumulate the tracked information in a database; and provide an incentive to the user for supplying the information about the product and/or the service.

In yet another aspect of the invention, information about the purchased products and/or the frequency in which an avatar is proximate to a predetermined special region within the VU is tracked. This information can be used to increase the incentive level offered to the avatar, thereby encouraging sticky behavior.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing the invention;

FIG. 2 shows a flow diagram of processing steps used in embodiments of the present invention;

FIG. 3 illustratively shows information tracked by an Information Tracking System according to embodiments of the present invention;

FIG. 4 illustratively shows a report of information tracked by the Information Tracking System according to embodiments of the present invention; and

FIG. 5 shows information associated with an Incentive System according to embodiments of the present invention.

### DETAILED DESCRIPTION OF THE INVENTION

The invention generally relates to a system and method for inquiring about products and providing incentives to users participating in a VU. More specifically, the present invention allows a user to purchase a product in the real world and receive incentives for the purchase within a VU. This can be done by entering, scanning, or obtaining information about a product into a computer while a user is participating in a VU. Once entered, the information obtained about the product, and the users that entered the information about the product, can be tracked and aggregated in a database. This information can later be provided to and used by businesses, VUs, etc., as marketing information in order to better understand customer trends and preferences.

It is beneficial for businesses to know the demographics of its customers in order to market to existing and prospective customers, as well as increase the stickiness associated with the business. Therefore, it is becoming more important for businesses to be able to track customer activities that occur in both the real world and in a VU. This is particularly important as more businesses start developing a presence in VUs and are faced with developing new marketing strategies to target VU users. The tracking of customer activities can be accomplished using the system and method of the invention.

In addition to tracking customer information, the present invention also provides incentives to the user that enters the product information. These incentives may be used while in the VU and include VU currency, points, inventory items, access to restricted areas, etc. Incentives may also be obtained in the VU and used in the real world, e.g., by providing coupons that may be used to purchase real world products and/or services. A benefit of providing incentives to VU users is that users are more likely to continue participating in the VU and are more likely to purchase a business's products and/or services, i.e., the stickiness associated with a business or VU will increase. Embodiments of the present invention allow for the stickiness associated with a business to be further increased by providing more incentives to VU users when the user is in a certain proximity of a business's virtual store, kiosk, etc., for predetermined amounts of time or when the user purchases certain items sold by the business.

### System Environment

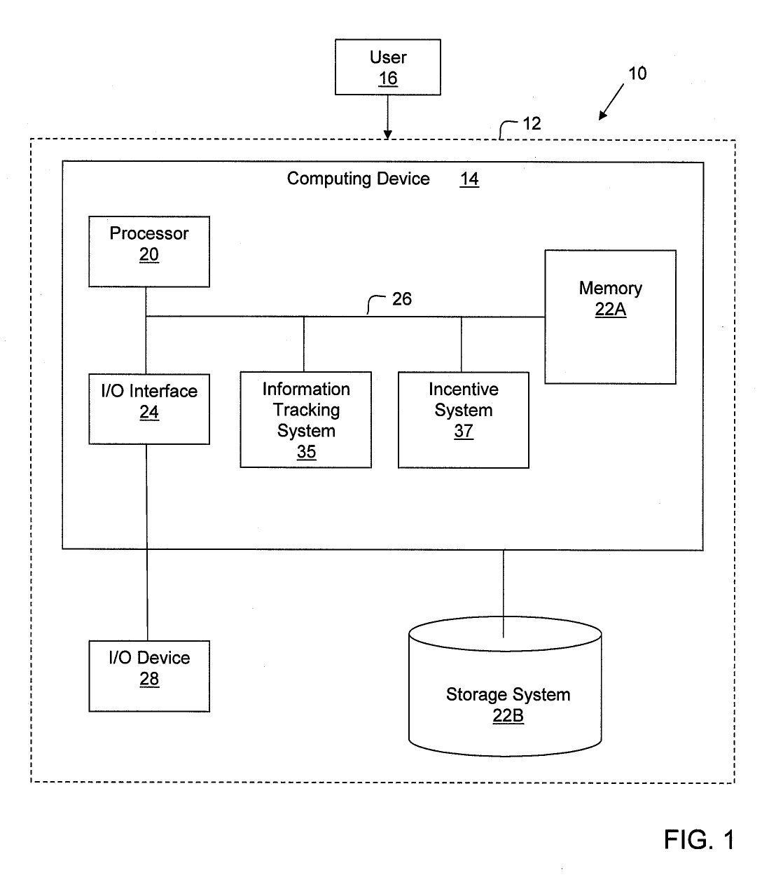

FIG. 1 shows an illustrative environment 10 for managing the processes in accordance with the invention. To this extent, the environment 10 includes a server 12 that can perform the processes described herein. In particular, the server 12 includes a computing device 14 that comprises an Information Tracking System 35, which makes the computing device 14 operable to obtain information about a product, service, and/or user. The computing device 14 also comprises an Incentive System 37, which makes the computing device 14 operable to provide one or more VU and/or real world incentives to a user participating in a Vu.

The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution. Further, the computing device 14 is in communication with an external I/O device/resource 28 and a storage system 22B. The I/O device 28 can comprise any device that enables an individual to interact with the computing device 14 or any device that enables the computing device 14 to communicate with one or more other computing devices using any type of communications link. The external I/O device/resource 28 may be keyboards, displays, pointing devices, scanners, radio frequency identification devices, bar code readers, etc. The storage system 22B can store information of the product, user, service, etc., obtained from the Information Tracking System 35. The storage system 22B can also store any number of incentives, which are used by the Incentive System 37.

In general, the processor 20 executes computer program code, which is stored in memory 22A and/or storage system 22B. The memory 22A stores computer program code, which implements the functionality of the Information Tracking System 35 and Incentive System 37. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the server 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the processes described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

### Exemplary Implementation of the System of the Invention

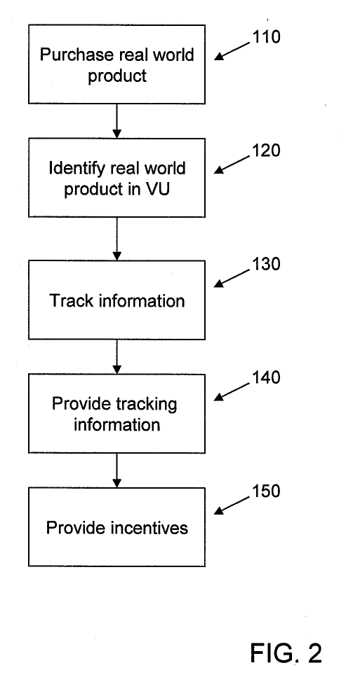

FIG. 2 shows a flow diagram of processing steps used in embodiments of the present invention. FIG. 2 may equally represent a high-level block diagram of components of the invention implementing the steps thereof. The steps of FIG. 2 may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM), e.g., memory 22A of FIG. 1. Additionally, the computer program code can be transferred to a workstation over the Internet or some other type of network.

The invention can take the form of an entirely hardware embodiment or an embodiment containing both hardware and software elements (any of which is referred generally as “file management program”). The hardware and software elements include a computer infrastructure configured to implement the functionality of the present invention. The computer infrastructure may take the form, for example, of the environment of FIG. 1. The software elements may be firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAN) and DVD.

Referring to FIG. 2, businesses can provide real world products and/or services that users can purchase, at step 110. These products and/or services include an identifier which is capable of being entered into a computer. This identifier can be unique or non-unique. Additionally, the identifier can be in a mechanical form, such as a serial number or barcode number, or it can be in an electrical form, such as a computer chip, microchip, or memory chip. A product's identifier can be located, e.g., on the product, on a product's packaging, or in a product's software. In the case of services, a service's identifier can be located on a physical item given to the user upon purchasing or using the service. Embodiments also allow product and/or service identifiers to be located on a receipt and for multiple identifiers to be associated with each product and/or service.

Once a product and/or service is purchased, it's identifier can be entered into a computer. The process of entering an identifier may include, for example, typing a code into a computer, optically scanning a product barcode, using radio frequency identification scanning, or any number of additional methods that allow information to be automatically or semi-automatically entered into a computer. Embodiments may require the identifier to be entered while the user's avatar is at a specific location in the VU or during a specific time period. The entered identifier can be stored in a database such as storage system 22B in FIG. 1. Once entered, the real world product and/or service is identified in the VU, at step 120.

Upon entering the product and/or service identifier, information associated with the product, service, and/or avatar can be saved and tracked, at step 130. This tracking may be performed by the VU or another entity. The information that is tracked may vary depending on the product, service, business, and/or VU. For example, a business using a barcode identifier can track information associated with the product, such as, e.g., the product identifier, the store the product was purchased at and the location of the store. Programmable identifiers may be able to track time or purchase, the purchase amount, and other information about the item such as transportation route, etc.

In addition to tracking information about products and/or services, information may also be tracked about the user that enters the product and/or service identifier. This information may include public and/or private information in an avatar's profile, how many times the avatar has entered the same or similar identifier, information on past identifiers entered by the user, including a history number, past product and/or service purchases, etc. Additionally, information can be tracked as to an avatar's proximity to a store or kiosk within the VU and/or an avatar's proximity to other participants in the VU that are interested in the product. Embodiments may also track information on how frequently a user, via the user's avatar, is proximate to a virtual store, a virtual kiosk, a collection of one or more products within a VU, and/or an exclusive product incentive area, etc. For example, an exclusive product incentive area may include a region of a VU, such as an IBM® Valley, where avatars can get together and view, use, and/or purchase exclusive products. (IBM is a registered trademark of International Business Machines Corporation, in the U.S. and throughout the world.)

Tracked information can be provided to one or more entities, at step 140. The entities obtaining this information may include the VU, the business that produces the product or offers the service, marketing agencies, a service provider, etc. The tracked information may be provided to one or more of these entities periodically or each time new data is obtained. Additionally, a fee may be charged for accessing the information as a rendered service. The fee can be agreed upon by the entities involved in the transaction and may include any number of payment methods used in the real world or in a VU.

After the information is tracked, or optionally before tracking the information, a user can be provided with an incentive for purchasing the product, at step 150. The incentives offered to a user can vary depending on the VU, business, and user. Exemplary incentives include, for example, VU currency, points, inventory items, access to restricted areas or functions, avatar function enhancement, avatar representation enhancement, virtual property, etc. Incentives may be given each time a product is purchased and entered; however, alternative embodiments may require a certain number of products and/or services to be purchased prior to providing an incentive to the user. The type of incentive given to the user may differ depending on the product, the information tracked about the user, the user's preferred incentive, the purchasing history and/or interests of the user, to name a few.

The processes illustrated in FIG. 2 are exemplary and it should be understood by those skilled in the art that more or fewer processes may be used in embodiments of the present invention. Additional processes may include, for example: storing information obtained about the real world product and/or service; identifying the proximity of the user's avatar to a virtual store, virtual kiosk, or virtual sales representative when the product and/or service identifier is entered; creating a report for one or more entities, etc. Furthermore, while the processes are described in a specific order, it should be understood that the order may be changed in embodiments. For example, embodiments may provide incentives to a user before tracking information about the user, products, and/or services. Embodiments may also allow information about a product and/or service to be tracked at a different time or in a different manner than the information about a user.

### Information Tracking System

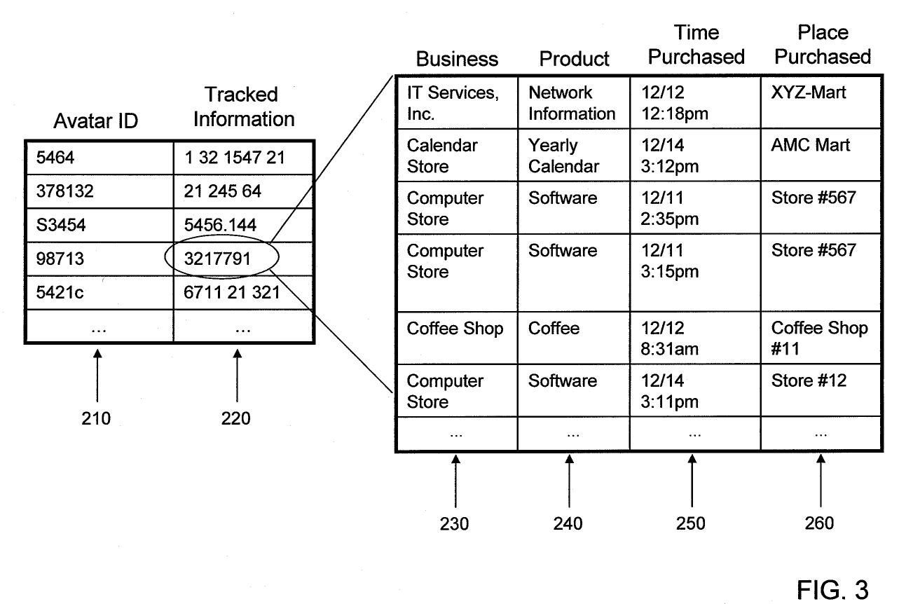

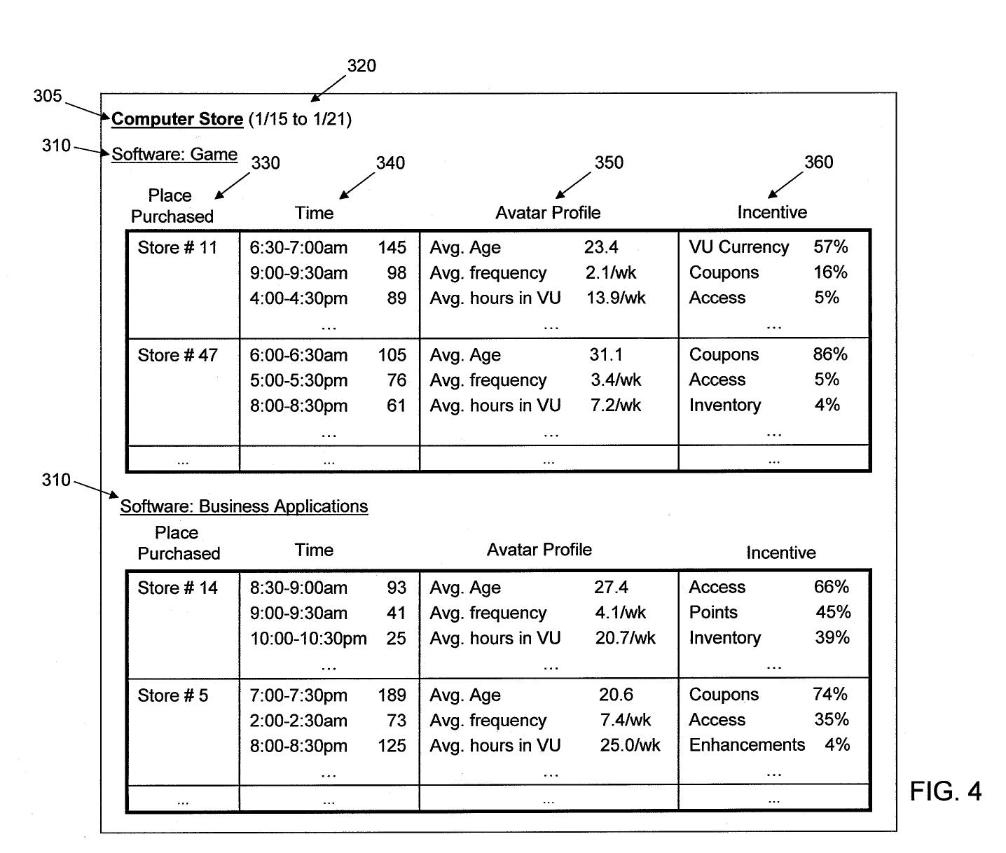

FIGS. 3 and 4 illustratively shows information tracked by the Information Tracking System of FIG. 1, in accordance with aspects of the present invention. The Information Tracking System can track information on avatars and the products and/or services purchased by the avatars. The information obtained from the Information Tracking System can be used to more effectively market to consumers. For explanatory purposes, FIG. 3 illustrates types of information that can be tracked by the Information Tracking System and FIG. 4 illustrates how tracked information may be presented to entities in a report.

Referring to FIG. 3, an avatar identifier is represented at column 210. This avatar identifier can be unique to an individual avatar or shared by a group of avatars. The avatar identifier may be numeric, alphanumeric, a username, a group name, an email associated with a user or group, etc. The information tracked when a user enters a product and/or service identifier can be stored in an avatar's profile, in a data structure referenced by a pointer, or via other data storage methods, at column 220. Specifically, the tracked information may be stored in the storage system 22B of FIG. 1. The method illustrated in FIG. 3 associates a pointer with an avatar ID, whereby the pointer points to a data structure holding tracked information about the avatar.

The type and amount of avatar information that is tracked can depend on the entity using the information, the VU, and the amount of information available on a user. The tracked information may include public and/or private information from an avatar's profile such as inventory of the avatar, a history of teleporting, or other movement around the VU, information downloaded or requested by the avatar, or even a finer granularity of information. Additionally, the Information Tracking System may track details on real world products and/or services purchased by the avatar and entered into the VU, such as, for example: the name of the business, as represented in column 230; a description of the product, as represented in column 240; the date and time the user purchased the product, as represented in column 250; and the location in which the product was purchased, as represented in column 260. Further information, including the price paid for a product, whether the product was on sale, etc., may also be tracked by the Information Tracking System.

For example, the Information Tracking System may identify that avatar ID #98713 purchased a number of real world products, such as computers, software, IT services, coffee, calendars, etc., and entered them while in the VU. Once the product and/or service is entered, the Information Tracking System can determine, e.g., that avatar #98713 purchased software on at least three occasions within three days, two of which were from store #567, and always in the afternoon. The information tracked by the Information Tracking System can be aggregated to build a profile about avatar #98713, or another avatar. Additionally, the information about avatar #98713 may be combined with tracked information about other avatars to determine trends, such as what real world products are popular amongst users participating in VUs. Based on this information, businesses can, e.g., emphasis these real world products in the VU and tailor their real world products to better appeal to customers participating in a vu.

Additional information about an avatar, product, and/or service may be included in FIG. 3. That is, the amount of information available on a product and/or service can fluctuate depending on the product and/or service identifier. For example, if the identifier is a number that has to be manually entered by a user, then there is a limit as to how long the identifier can feasibly be such that the user will still enter the identifier. Therefore, the shorter the identifier, the less information about the place the product was sold, what time the product was sold, etc., can be obtained about the product and/or service. Conversely, if a radio frequency identifier or another automatic or semi-automatic data entry device is used, then the burden on the customer to enter the information is decreased and the amount of data and the detail of the data can be increased.

Embodiments may require the identifier be entered while the customer is within a certain proximity of a VU business, kiosk, product, etc. Alternatively, embodiments may allow a customer to enter the identifier and be automatically transported to a new product area, a virtual kiosk, and/or an exclusive frequent purchaser area where the user can purchase additional products and/or services. The user may also be teleported to an area to receive incentives for the user's previously purchased products and/or services.

For example, when an avatar enters an identifier or product code via any of the above described methods, the avatar may be teleported to a VU business, kiosk having the product, or a new product area having one or more of the businesses new or yet to be released products. Embodiments may also transport an avatar to a more exclusive area if the avatar is a frequent customer, has entered a special code, etc. For example, an avatar may get increasingly lucrative incentives as the avatar enters more identifiers, spends more time in the proximity of product kiosks, speaks with a certain number of avatars within a proximity of a business, and/or product kiosk, etc.

It is beneficial for businesses to have avatars spend time in the proximity of a VU business, product kiosk, etc. For example, the avatar is more likely to be exposed to the businesses products and/or services when in the proximity of the business, product kiosk, etc. This exposure allows the avatar to learn more about the businesses product line, tell others about one or more of the products, and/or purchase products from the business, thereby increasing the stickiness associated with a business.

It is also beneficial for avatars visiting a business, product kiosk, etc., to be proximate to other avatars who are interested in a product. This allows avatars to discuss the product and learn about new products from other avatars. Additionally, while the avatars are speaking to one another, other avatars in the proximity can hear about the business and/or product, thereby promoting products via word of mouth and increasing the stickiness associated with the business.

FIG. 4 illustratively shows a report of product information tracked by the Information Tracking System according to embodiments of the present invention. The report illustrated in FIG. 4 is merely illustrative of one type of report and should not be considered a limitation of the present invention. The report of FIG. 4 is directed to a business 305 having one or more real world products 310, which may be entered into a VU. This report may include all of the information gathered about a product 310 or a subset of the gathered information, e.g., information on products 310 purchased during a specific time period 320. Any number of data fields may be displayed within the report, such as: the place the product and/or service was purchased, as represented in column 330; the time the product and/or service was purchased, as represented in column 340; information about the avatar profile of the user that entered the product identifier into the VU, as represented in column 350; the incentive chosen by the user while in the VU, as represented in column 360; etc. The amount of information presented in a report may depend on the amount of information that is available and how much information is requested by an entity.

For example, FIG. 4 includes a report for a business 305 named “Computer Store.” The specific time period 320 covered by the report is from January 15^{th} through January 21^{st}. The types of products 310 illustrated in the report include specific types of software, namely games and business applications. The report identifies a specific store location and how many of the specific products were sold at specific times of the day. Therefore, upon reviewing this report, the Computer Store can determine that between January 15^{th} and January 21^{st} store #11 sold the most real world software games that were later entered into a VU by one or more users. Of the software games sold at store #11, the most software games were sold between 6:30 and 7:00 am. The average age of the user that entered the identifying information was 23.4 and the average frequency, or number of times per week the user entered information on the specific product was 2.1 times per week. Additional information about the users may be obtained, such as the average number of hours the user participates in the VU per week. Also included in the report, as illustrated in FIG. 4, is a break down of the most popular incentives received by the avatar. This type of information helps businesses to focus its geographical and demographical marketing strategies to reach targeted purchasers. Additionally, it allows businesses to determine what incentives are most popular amongst it customers, thereby increasing brand loyalty and the stickiness associated with a product.

Additional information can also be tracked by the Information Tracking System and reported to businesses. For example, the Information Tracking System can track information on how proximate a user is to a business when entering a product identifier, how much interaction the user had with others while in the proximity of a VU business, how frequently the avatar enters a certain proximity of a VU business, kiosk, etc. By reporting tracked information to business, it allows businesses to better identify and reward frequent customers, entice new customers to spend more time and money buying products, etc. Thus the Information Tracking System provides businesses with a resource that allows them to increase the stickiness associated with the business.

While access to information tracked by the Information Tracking System may be offered at no charge to participating entities, embodiments may also charge a fee for some or all of the tracked information by a service provider. Additionally, embodiments may charge a fee for providing specific reports to entities.

### Incentive System

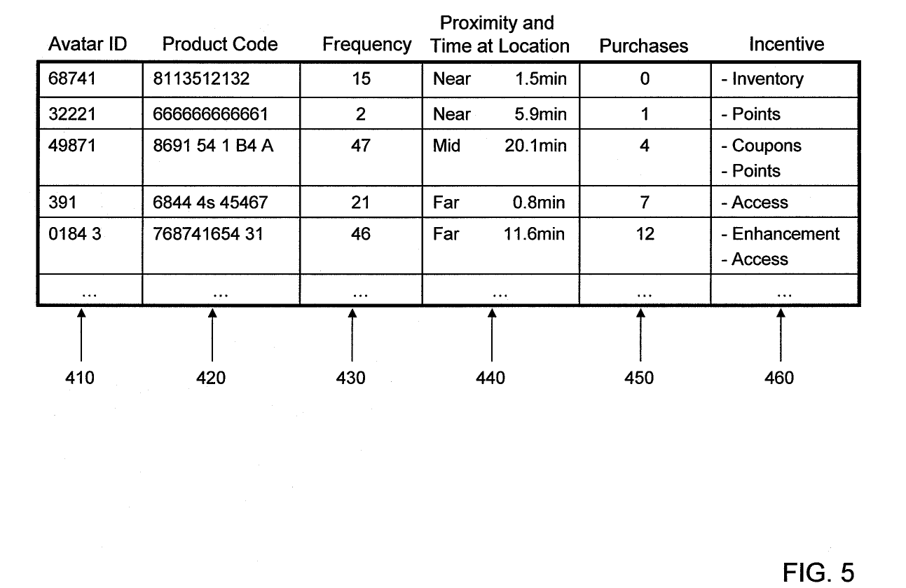

FIG. 5 shows information associated with an Incentive System according to embodiments of the present invention. Generally, the Incentive System keeps track of the types of incentives that are available and distributes incentives to users according to some predefined method. In order for the Incentive System to distribute incentives, the Incentive System determines who is going to receive the incentive. This may be done by identifying the avatar ID associated with a user, as represented in column 410.

The Incentive System can also identify the product entered by a user, as represented in column 420. The product can be identified by its product code, barcode, radio frequency identification tag, etc. The name of the business that owns the product and/or offers the service can be included as part of the product and/or service identifier as well as specific information on the types of incentives available to a user for the product and/or service.

Once the product identifier is entered into the computer, the Incentive System can determine how many of the products and/or services should be purchased and entered before an incentive can be provided to the user. The frequency, or number of times a user enters a specific or related product and/or service into a VU, can be tracked, as illustrated in column 430. This frequency can reflect the total number of purchases made by the user or the number of purchases made by a user within a specified time period.

For example, suppose a business sells software products and decides to provide access to a VU “software land” as an incentive for users that purchase the product. In order to sell more real world products, the business may not want to automatically grant every user that buys a software product access to the VU software land. Instead, the business may want to require that at least a certain number of software products be purchased and entered before the user is granted access to the VU software land. Using the frequency information can help businesses to easily determine how many software products a user has purchased and whether the user's avatar should be admitted access to the VU software land. Additionally, the frequency information may also be used to determine which users purchase the largest numbers of software products and provide additional incentives to those users.

Embodiments may require that certain conditions be met before the user is entitled to an incentive. These conditions may require that an avatar be in a certain proximity to a virtual store, kiosk, virtual sales representative, object, teleportation device, etc., for a specified amount of time, as illustrated in column 440. For example, in embodiments, a user may only be allowed to enter and receive an incentive associated with a particular product identifier when the user's avatar is at a store or kiosk that sells the business's goods.

As an incentive, embodiments may automatically teleport and avatar to a store, kiosk, etc., as soon as the user enters in a product and/or service identifier. This allows businesses to get avatars to come to their virtual stores or kiosks where their products, services, real world and/or VU events, and/or trends, such as healthy eating or exercise, can be promoted. Additionally, once an avatar spends time in a virtual store, kiosk, etc., avatars are more likely to purchase products and/or services from the virtual store and return to the virtual store, thereby increasing the stickiness associated with the business.

In addition to requiring that product identifiers be entered within a certain proximity of a location, embodiments may provide different incentives depending on the amount of time an avatar spends within a certain proximity of a location. The more time an avatar spends at a location, the more likely the avatar will either purchase virtual products and/or begin talking to other avatars about the business. This “word of mouth” helps to increase the stickiness associated with a business and may be rewarded by, e.g., providing increased incentives to those avatars that remain in the proximity of a virtual location for extended periods of time. Additionally, to increase the stickiness associated with a business, embodiments may limit the number of avatars allowed within a certain proximity of a location during a period of time, thereby increasing the likelihood that avatars will interact with one another or a virtual sales representative.

While interacting in a VU, a user's avatar may purchase products and/or services from businesses within the VU. The number of purchases a user makes while in the VU can be tracked, in column 450. Additional information about the products and/or services that a user purchases while in the VU can also be tracked via the Information Tracking System, as shown in FIG. 1.

Different types of incentives can be made available to users, as represented in column 460. The incentives can include, for example, VU currency, points, inventory items, access to restricted areas or functions, avatar function enhancements, avatar representation enhancement, virtual property, coupons, etc. The types of incentives may vary between products, services, businesses, and VUs. For example, a business selling products in the real world may offer an inventory incentive to users within a VU. The inventory may be a virtual representation of the real world product purchased by the user. However, embodiments also permit any number of non-product or service related incentives to be provided to the user. For example, instead of receiving a virtual product, a user may receive VU currency to spend at the business's virtual store.

The type of incentives available to a user can be predetermined by the VU, the business selling the product and/or service, etc. A user may be allowed to select one or more of the available incentives. The number of incentives a user can select from may be limited or unlimited. Factors that can influence how many choices an avatar is presented with include the frequency in which the user purchases products and/or services from a company. The number and/or types of incentives may also be based on an analysis of a user's past incentives, which may be obtained from the Information Tracking System.

Incentives can be used within a VU and/or in the real world. For example, a user may enter an identifier for a product purchased in the real world and receive a coupon as an incentive for the purchase. This coupon may be worth a specific amount if used within the VU and worth the same or a different amount if used in the real world. Therefore, a user can obtain a real world benefit from incentives received in a VU.

Although many examples have been given that include purchasing a real world product and/or service to obtain incentives within a VU, it should be understood that the present invention is not limited to these types of embodiments. For example, the present invention contemplates purchasing a real world product and/or service and obtaining real world incentives once the product and/or service is entered into a VU. Additionally, the present invention contemplates purchasing virtual products and/or services and obtaining real world incentives and/or VU incentives for these purchases.

### Exemplary Processes in Accordance with the Invention

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

While the invention has been described in terms of embodiments, those skilled in the art will recognize that the invention can be practiced with modifications and in the spirit and scope of the appended claims. Additionally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A system comprising:
an information tracking system configured to track information about at least one of a product, a service, and one or more users purchasing the product or service based on obtained information associated with the product or service and the one or more users; and
a storage system configured to aggregate information obtained from the information tracking system to build a user profile within a virtual universe.

2. The system of claim 1, wherein the information tracking system tracks how frequently the one or more users are proximate to at least one of a virtual store, a virtual kiosk, a collection of one or more products within a virtual universe, and an exclusive product incentive area.

3. The system of claim 1, wherein the information tracking system tracks at least one of: a product description, a place of purchase, a time of purchase, a purchase price, and a user ID.

4. The system of claim 1, wherein the information tracking system tracks at least one of real world purchases and virtual universe purchases.

5. The system of claim 1, wherein the information on the one or more users is obtained from at least one of a public user profile and a private user profile.

6. The system of claim 1, wherein the information on the one or more users includes at least one of the purchase of the product and/or the service and locations within the virtual universe.

7. The system of claim 1, further comprising an incentive system configured to provide one or more incentives to the one or more users for purchasing at least one of the product and the service, the one or more incentives include at least one of virtual universe currency, points, inventory items, access to restricted areas or functions, enhancements, virtual property, and coupons.

8. The system of claim 7, wherein the one or more incentives are usable in at least one of a real world and a virtual universe.

9. The system of claim 7, wherein the one or more incentives are provided to the user when the user is proximate to a predefined virtual location.

10. The system of claim 7, wherein the at least one of the product and the service are entered by the one or more users and the one or more users are automatically teleported to a new product area, a virtual kiosk, and/or an exclusive frequent purchaser area.

11. The system of claim 10, wherein the predefined virtual location is at least one of a virtual store and virtual kiosk.

12. The system of claim 11, wherein the one or more incentives change in relation to an amount of time the user spends proximate to the virtual store, the virtual kiosk, and/or a virtual sales representative.

13. The system of claim 1, wherein the tracking and the storing are implemented on a computer infrastructure.

14. A method for tracking information in a virtual universe comprising:
tracking information on at least one of a product, a service, or a user;
aggregating the tracked information in a database; and
generating a profile on at least one of the product, the service, or the user based on the tracked information.

15. The method of claim 14, further comprising providing the generated profile to one or more entities for a fee or on a subscription basis.

16. The method of claim 14, further comprising providing incentives to the user based on the tracked information.

17. The method of claim 16, wherein the incentives include at least one of virtual universe currency, points, inventory items, access to restricted areas or functions, enhancements, virtual property, and coupons.

18. A system for deploying an application for tracking information, comprising:
a computer infrastructure being operable to:
track product information, service information, and user information in a virtual universe;
aggregate the tracked product, service, and user information in a database; and
provide the tracked product, service, and user information to one or more entities.

19. The system of claim 18, wherein the product information and the service information is derived from entering a product identifier and a service identifier respectively into a computing device.

20. The system of claim 19, wherein the product identifier and the service identifier is one or more of a serial number, barcode, radio frequency identification, or a receipt.

21. The system of claim 19, wherein the product identifier and/or the service identifier is stored on a computer chip, microchip, or memory chip.

22. The system of claim 18, wherein the computing infrastructure is at least one of supported, deployed, maintained, and created by a service provider.

23. A computer program product comprising a computer usable storage medium having computer readable program code embodied in the medium operable to:
track information about a product, a service, and/or a user in a virtual universe;
accumulate the tracked information about the product, the service, and/or the user in a database; and
provide an incentive to the user for supplying the information about the product and/or the service.

24. The computer program product of claim 23, wherein the tracked information is about a virtual product and/or a virtual service.

25. The computer program product of claim 23, wherein the computer program product is provided on a computing infrastructure, which is at least one of supported, deployed, maintained, and created by a service provider.
